(19) United States
(12) Patent Application Publication
(10) Pub. No.: US 2026/0370307 A1
(43) Pub. Date: Nov. 19, 2026

(54) METHOD AND DEVICE FOR DETERMINING UNIFIED TRANSMISSION CONFIGURATION INDICATOR STATE, AND STORAGE MEDIUM

(71) Applicant: Beijing Xiaomi Mobile Software Co., Ltd., Beijing (CN)

(72) Inventors: Liangang CHI, Beijing (CN); Gaoming DUAN, Beijing (CN)

(21) Appl. No.: 19/126,203

(22) PCT Filed: Nov. 6, 2022
(86) PCT No.: PCT/CN2022/130176

§ 371 Date: Apr. 30, 2025

(51) Int. Cl. H04B 7/06; H04L 5/00; H04W 72/231; H04W 80/02

(52) U.S. Cl. CPC H04B 7/06968; H04L 5/0051; H04W 72/231; H04W 80/02

(57) ABSTRACT

A method for determining a unified transmission configuration indicator state including: receiving first indicator information transmitted by a network device, where the first indicator information is configured to indicate the number of unified TCI state groups corresponding to Unified TCI state set in different Unified TCI state sets in a Unified TCI state list, and the number of Unified TCI states corresponding to Unified TCI state group in Unified TCI state set; and at least one of a different target channel of the terminal or reference signals corresponding to the target channel share a beam indicated by the Unified TCI state, and the target channel includes at least one of uplink channels or downlink channels.

### CROSS-REFERENCE TO RELATED APPLICATIONS

The present application is a U.S. National Stage of International Application No. PCT/CN 2022/130176, filed on Nov. 6, 2022, the contents of all of which are incorporated herein by reference in their entireties for all purposes.

### BACKGROUND OF THE INVENTION

Multi-Transmission Reception Points (M-TRPs) serve a terminal in a Multiple-Input Multiple-Output (MIMO) technology, thus ensuring signal quality of the terminal better, and satisfying service requirements of the terminal for a high speed and high capacity. Different TRPs are spatially located at different positions, and large-scale fading corresponding to each TRP varies dramatically in a New Radio (NR) technology. As a result, it is necessary to separately indicate beam information corresponding to different TRPs for the TRPs during transmission based on the M-TRP.

### SUMMARY OF THE INVENTION

The present disclosure relates to the technical field of communication, and in particular to a method and device for determining a unified transmission configuration indicator (Unified TCI) state, and a storage medium.

According to a first aspect of an embodiment of the present disclosure, a method for determining a Unified TCI state is provided. The method is performed by a terminal, and includes: receiving first indication information transmitted by a network device, where the first indication information is configured to indicate the number of Unified TCI state groups corresponding to a Unified TCI state set in different Unified TCI state sets in a Unified TCI state list, and the number of Unified TCI states corresponding to the Unified TCI state group in the Unified TCI state set; and

at least one of a different target channel of the terminal or reference signals corresponding to the target channel share a beam indicated by the Unified TCI state, and the target channel includes at least one of uplink channels or downlink channels.

According to a second aspect of an embodiment of the present disclosure, a method for determining a Unified TCI state is provided. The method is performed by a network device, and includes: transmitting first indication information to a terminal, where the first indication information is configured to indicate the number of Unified TCI state groups corresponding to a Unified TCI state set in different Unified TCI state sets in a Unified TCI state list, and the number of Unified TCI states corresponding to the Unified TCI state group in the Unified TCI state set; and

at least one of a different target channel of the terminal or reference signals corresponding to the target channel share a beam indicated by the Unified TCI state, and the target channel includes at least one of uplink channels or downlink channels.

According to a third aspect of an embodiment of the present disclosure, a communication device is provided. The device includes: one or more processors; and a memory for storing processor-executable instructions, where the one or more processors are collectively configured to perform the processor-executable instructions to cause the communication device to: receive first indication information transmitted by a network device, wherein the first indication information is configured to indicate the number of Unified TCI state groups corresponding to a Unified TCI state set in different Unified TCI state sets in a Unified TCI state list, and the number of Unified TCI states corresponding to a Unified TCI state group in a Unified TCI state set; and

at least one of a different target channel of the terminal or reference signals corresponding to the target channel share a beam indicated by the Unified TCI state, and the target channel includes at least one of uplink channels or downlink channels.

According to a fourth aspect of an embodiment of the present disclosure, a communication device is provided. The device includes: one or more processors r; and a memory for storing processor-executable instructions, where the one or more processors are collectively configured to perform processor-executable instructions to cause the communication device to implement the method for determining a unified transmission configuration indicator (Unified TCI) state according to the above second aspect and any implementation of the second aspect.

According to a fifth aspect of an embodiment of the present disclosure, a non-transitory computer-readable storage medium is provided. The storage medium stores instructions, and the instructions in the storage medium, when executed by one or more processors of the terminal, enable a terminal to perform the method according to the above first aspect and any implementation of the first aspect.

According to a sixth aspect of an embodiment of the present disclosure, a storage medium is provided. The storage medium stores instructions, and the instructions in the storage medium, when executed by one or more processors of the network device, enable a network device to perform the method according to the above second aspect and any implementation of the second aspect.

According to a seventh aspect of an embodiment of the present disclosure, a communication system is provided. The communication system includes a terminal and a network device, where the terminal is configured to perform the method according to the above first aspect and any implementation of the first aspect; and the network device is configured to perform the method according to the above second aspect and any implementation of the second aspect.

It should be understood that the above general description and the following detailed description are illustrative and explanatory, and cannot limit the present disclosure.

### BRIEF DESCRIPTION OF DRAWINGS

The accompanying drawings here are incorporated in the description as a constituent part of the description, illustrate embodiments conforming to the present disclosure, and serve to explain the principles of the present disclosure along with the description.

FIG. 1 is a schematic diagram of a wireless communication system according to an example;

FIG. 2 is a schematic diagram of a unified transmission configuration indicator (Unified TCI) state list according to an example;

FIG. 3 is a flowchart of a method for determining a Unified TCI state according to an example;

FIG. 4 is a schematic diagram of Unified TCI state list according to an example;

FIG. 5 is a schematic diagram of a Unified TCI state list according to an example;

FIG. 6 is a flowchart of a method for determining a Unified TCI state according to an example;

FIG. 7 is a flowchart of a method for determining a Unified TCI state according to an example;

FIG. 8 is a flowchart of a method for determining a Unified TCI state according to an example;

FIG. 9 is a block diagram of a device for determining a Unified TCI state according to an example;

FIG. 10 is a block diagram of a device for determining a Unified TCI state according to an example;

FIG. 11 is a block diagram of a communication device according to an example; and

FIG. 12 is a block diagram of a communication device according to an example.

### DETAILED DESCRIPTION OF THE INVENTION

The examples will be described in detail here and are illustratively shown in the accompanying drawings. When the following description refers to the accompanying drawings, the same numbers in different accompanying drawings represent the same or similar elements unless otherwise indicated. The implementations described in the following examples do not denote all implementations consistent with the present disclosure.

Multi Transmission Reception Points (M-TRPs) serve a terminal in a Multiple-Input Multiple-Output (MIMO) technology, thus ensuring signal quality of the terminal better, and satisfying service requirements of the terminal for a high speed and high capacity. Different TRPs are spatially located at different positions, and large-scale fading corresponding to each TRP varies dramatically in a New Radio (NR) technology. As a result, it is necessary to separately indicate beam information corresponding to different TRPs for the TRPs during transmission based on the M-TRP.

In the related art, a downlink beam can be indicated via a Transmission Configuration Indicator (TCI) state, and an uplink beam can be indicated via Space Relation Information (SRI). In millimeter-wave deployment, a downlink receiving beam and an uplink transmitting beam of the terminal are typically symmetrical, and the same beam can be used between different channels and signals of the terminal. Thus, a Unified Transmission Configuration (Unified TCI) state is introduced to reduce signaling consumption, via which the uplink beam and the downlink beam can be uniformly indicated.

Indication of the uplink beam and the downlink beam by the Unified TCI state in the related art is merely applicable to a Single Transmission Reception Point (S-TRP).

As noticed by the inventor, when the terminal may receive the same single downlink control information (S-DCI) by a plurality of beams in a scenario of transmission by the network device for the terminal by the M-TRP, how to determine a Unified TCI state corresponding to each TRP by the terminal is a problem to be solved.

In order to solve the problem existing in the related art, the present disclosure provides a method and device for determining a unified transmission configuration indicator (Unified TCI) state, and a storage medium.

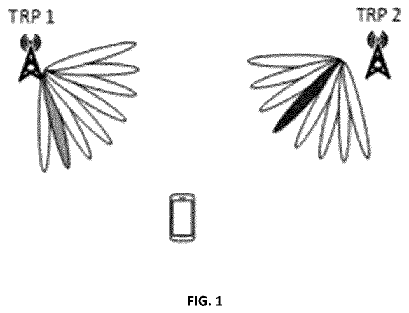

A method for determining a Unified TCI state according to an embodiment of the present disclosure is performed by a wireless communication system shown in FIG. 1. With reference to FIG. 1, the wireless communication system includes a network device and a terminal. The terminal is connected to the network device by wireless resources, and transmits data.

It may be understood that the wireless communication system shown in FIG. 1 is merely illustrative. The wireless communication system may further include other network devices, for example, a core network device, a wireless relay device, a wireless backhaul device, etc., which are not shown in FIG. 1. The number of network devices and the number of terminals included in the wireless communication system are not limited in the embodiment of the present disclosure.

Further, it may be understood that the wireless communication system of the embodiment of the present disclosure is a network providing a wireless communication function. Different communication technologies, such as code division multiple access (CDMA), wideband code division multiple access (WCDMA), time division multiple access (TDMA), frequency division multiple access (FDMA), orthogonal frequency-division multiple access (OFDMA), single Carrier FDMA (SC-FDMA), and Carrier Sense Multiple Access with Collision Avoidance (CSMA), may be configured to the wireless communication system. The network may be divided into a second-generation (2G) network, a third-generation (3G) network, a fourth-generation (4G) network or a future evolution network such as a fifth-generation (5G) network according to factors of capacity, a rate, a delay, etc. of different networks. The 5G network may also be referred to as a New Radio (NR) network. For ease of description, the wireless communication network is sometimes referred to as a network in the present disclosure.

Further, the network device involved in the present disclosure may also be referred to as a radio access network device. The radio access network device may be a base station, an evolved node B, a home base station, and an access point (AP), a wireless relay node, a wireless backhaul node, a transmission point (TP), or a transmission and reception point (TRP) in a wireless fidelity (WIFI) system, may be further a next generation node B (gNB) in an NR system, or may be further a component or part of a device constituting the base station. It should be understood that a specific technology and a specific device form used by the network device are not limited in the embodiment of the present disclosure. In the present disclosure, the network device may provide communication coverage for a particular geographic area and may communicate with terminals located in the coverage area (cell). Moreover, the network device may be further a vehicle-mounted device in a case of a vehicle to X (V2X) communication system.

Further, the terminal involved in the present disclosure may also be referred to as a terminal device, User Equipment (UE), a Mobile Station (MS), a Mobile Terminal (MT), etc., and is a device for providing voice and/or data connectivity to a user. For example, the terminal may be a handheld device or a vehicle-mounted device having a wireless connection function. At present, some terminals include, for example, a Mobile Phone, Customer Premise Equipment (CPE), a Pocket Personal Computer (PPC), a palm computer, a Personal Digital Assistant (PDA), a notebook computer, a tablet computer, a wearable device, or a vehicle-mounted device. Moreover, the terminal device may be further a vehicle-mounted device in a case of a V2X communication system. It should be understood that a specific technology and a specific device form used by the terminal are not limited in the embodiment of the present disclosure.

Owing to continuous development of wireless communication, the requirement of a communication capability is increasingly high. Ultra-high-speed, ultra-low-delay and ultra-large-bandwidth communication becomes normal in future-oriented application scenarios such as Augmented Reality (AR) or Virtual Reality (VR), Internet of Vehicles and Internet of Things. In order to satisfy the requirement, an increasing number of new technologies are provided.

An MIMO technology has opened a new era for development and utilization of spatial resources in a mobile communication system. Distributed MIMO is developed based on a traditional typical MIMO technology, and expands an application range of the traditional MIMO. The distributed MIMO may not merely be applied to a single-cell cellular base station system, but also further replace a multi-cell cellular base station to form a cell-free mobile communication system in a form of distributed multi-user multiple-input multiple-output (MU-MIMO), i.e. a cell-free technology. The cell-free technology may provide services for all users in a case of the same time-frequency resources, and does not need to traditionally divide inter-cell frequencies. System resources may be dynamically scheduled in all aspects. Thus, flexibility of configuration of existing system resources may be improved, and utilization of the resources may be greatly improved.

M-TRPs serve a terminal in the MIMO technology, thus ensuring signal quality of the terminal better, and satisfying service requirements of the terminal for a high speed and high capacity. Different TRPs are spatially located at different positions, and large-scale fading corresponding to each TRP varies dramatically in a New Radio (NR) technology. As a result, it is necessary to separately indicate beam information corresponding to different TRPs for the TRPs during transmission based on the M-TRP.

In the related art, a downlink beam can be indicated via a TCI state, and an uplink beam can be indicated via SRI. In millimeter-wave deployment, a downlink receiving beam and an uplink transmitting beam of the terminal are typically symmetrical, and the same beam can be used between different channels and signals of the terminal. Thus, a Unified TCI state is introduced in R17 to reduce signaling consumption, via which the uplink beam and the downlink beam can be uniformly indicated. An indication of the Unified TCI state has been standardized in the R17, but merely a connection of an S-TRP is supported.

The indication of the Unified TCI state for the S-TRP in the R17 will be described below.

The network device configures at most K Unified TCI states for the terminal via a Radio Resource Control (RRC) signaling, activates some of the Unified TCI states via a Medium Access Control Control Element (MAC-CE), and may indicate an activated Unified TCI state as a Unified TCI state of the TRP via a Unified TCI information field in downlink control information (DCI).

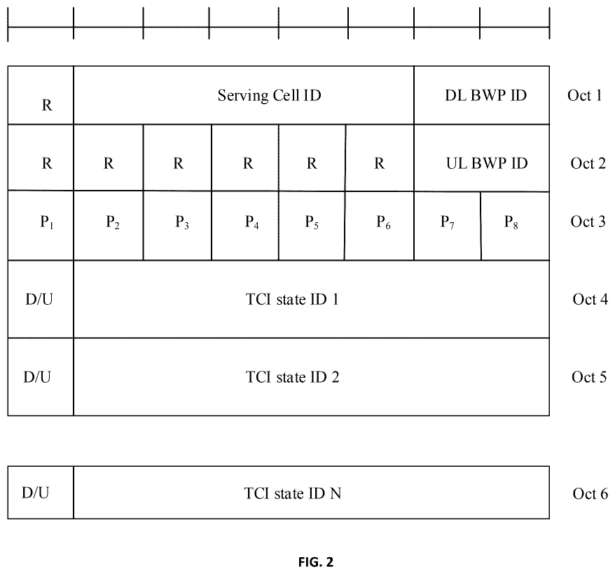

As shown in FIG. 2, a format chart of a Unified TCI state list in an MAC-CE in the related art is shown.

Oct refers to an octet. The octet consists of eight bits. In order to distinguish different bytes, the octets are marked as an Oct1, an Oct2, etc. The Oct1 may be referred to as a first octet, and the Oct2 may be referred to as a second octet. It should be understood that the first octet, the second octet, etc. are merely names for distinction, and do not limit the scope of protection of the embodiment of the present disclosure.

Severing Cell ID: the field indicates an identity (ID) of a serving cell to which the MAC-CE is applied, and may have a length of 5 bits.

DL BWP ID: the field includes an ID corresponding to a downlink bandwidth part to which the MAC-CE is applicable. BWP ID is provided by a high-level parameter BWP ID specified in 3GPP TS 38.331. The DL BWP ID has a length of 2 bits.

UL BWP ID: the field includes an ID corresponding to an uplink bandwidth part to which the MAC-CE is applicable. BWP ID is provided by a high-level parameter BWP ID specified in 3GPP TS 38.331. The UL BWP ID has a length of 2 bits.

R: reserved bit.

Pi (a value may be P1-P7): the field indicates a Unified TCI state corresponding to each Unified TCI state group. Illustratively, if Pi is set to 1, it indicates that an i-th Unified TCI state group corresponds to a joint Unified TCI state; and if Pi is set to 0, it indicates that the i-th Unified TCI state group is an uplink Unified TCI state or an uplink and downlink Unified TCI state.

D/U: the field indicates whether an N-th group of Unified TCI states of TCI state ID N are the uplink Unified TCI state or the uplink and downlink joint Unified TCI state.

Indicating the uplink beam and the downlink beam via the Unified TCI state in the related art is merely applicable to an S-TRP.

In the future, owing to increasing maturity of the distributed MIMO technology, TRPs for joint transmission is increasingly increased. At present, R18 has started to discuss at most 4 TRP connections. In an M-TRP scenario, a TCI state indication is further divided into two modes of an indication based on S-DCI and an indication based on Multiple Downlink Control Information (M-DCI). The solution provides a solution for the Unified TCI state indication in an M-TRP scenario based on the S-DCI.

Based on this, a method for determining a Unified TCI state is provided in the embodiment of the present disclosure. A terminal device receives first indication information transmitted by a network device. The first indication information is configured to indicate the number of Unified TCI state groups corresponding to each Unified TCI state set in different Unified TCI state sets in a Unified TCI state list, and the number of Unified TCI states corresponding to each Unified TCI state group in each Unified TCI state set. Thus, when a plurality of TRPs share one piece of DCI, the terminal can determine, based on the first indication information, the Unified TCI state corresponding to each TRP in one Unified TCI state list. Thus, a Unified TCI state indication solution in an M-TRP scenario based on S-DCI is implemented.

In order to more easily understand the solution according to the embodiment of the present disclosure, terms involved in the embodiment of the present disclosure are explained:

Unified TCI state set: the term represents part of K TCI states configured by an RRC signaling activated by the MAC-CE for the terminal. At present, the MAC-CE may activate at most 8 Unified TCI state sets. One Unified TCI state set corresponds to a code point in a TCI information field in one piece of DCI.

Unified TCI state group: one or more Unified TCI state groups form one Unified TCI state set, the number of the Unified TCI state groups included in each Unified TCI state set is the same as the number of TRPs connected to the terminal, one Unified TCI state group includes one or more Unified TCI states, and the Unified TCI states included in the same Unified TCI state group indicate Unified TCI states of the same TRP.

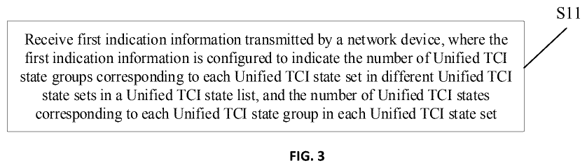

FIG. 3 is a flowchart of a method for determining a Unified TCI state according to an example. As shown in FIG. 3, the method for determining a Unified TCI state is performed by a terminal, and includes the following steps.

In step S11, first indication information transmitted by a network device is received, where the first indication information is configured to indicate the number of Unified TCI state groups corresponding to each Unified TCI state set in different Unified TCI state sets in a Unified TCI state list, and the number of Unified TCI states corresponding to each Unified TCI state group in each Unified TCI state set.

In the embodiment of the present disclosure, the terminal receives the first indication information transmitted by the network device. The first indication information is configured to indicate the number of the Unified TCI state groups corresponding to each Unified TCI state set in the different Unified TCI state sets in the Unified TCI state list, and the number of the Unified TCI states corresponding to each Unified TCI state group in each Unified TCI state set. Thus, when the plurality of TRPs share one piece of DCI, the terminal can determine, based on the first indication information, the Unified TCI state corresponding to each TRP in one Unified TCI state list. Thus, a Unified TCI state indication solution in an M-TRP scenario based on S-DCI is implemented.

At least one of a different target channel of the terminal or reference signals corresponding to the target channel share a beam indicated by the Unified TCI state, and the target channel includes at least one of uplink channels or downlink channels.

In some embodiments, if a Unified TCI state is an uplink TCI state, a beam indicated by the TCI state is applicable to at least one of a physical uplink shared channel (PUSCH), a demodulation reference signal (DMRS) of the PUSCH, at least part of physical uplink control channels (PUCCHs), DMRSs of the PUCCHs, or at least part of sounding reference signals (SRSs) of the terminal.

In some other embodiments, if a Unified TCI state is a downlink TCI state, a beam indicated by the TCI state is applicable to at least one of a physical downlink shared channel (PDSCH), a DMRS of the PDSCH, at least part of physical downlink control channels (PDCCHs), DMRSs of the PDCCHs, or at least part of channel state information-reference signals (CSI-RSs) of the terminal.

In some other embodiments, if a Unified TCI state is an uplink and downlink joint TCI state, a beam indicated by the uplink and downlink joint TCI state is applicable to at least one of both an uplink channel and a downlink channel of the terminal or reference signals corresponding to the uplink channel and the downlink channel.

In the method for determining a Unified TCI state according to the embodiment of the present disclosure, the number of the Unified TCI state groups and the number of TRPs have a corresponding relation.

In some embodiments, a corresponding relation between the number of Unified TCI state groups and the number of TRPs is a display corresponding relation. Illustratively, one Unified TCI state group corresponds to a TRP. That is, Unified TCI states included in the same Unified TCI state group indicate Unified TCI states of the same TRP.

For example, if a first Unified TCI state set in a Unified TCI state list indicated by first indication information includes 2 Unified TCI state groups, the terminal supports a connection of 2 TRPs.

In some other embodiments, a corresponding relation between the number of Unified TCI state groups and the number of TRPs is an implicit corresponding relation. Illustratively, a Unified TCI state set corresponds to N TRPs. Thus, one Unified TCI state set includes N Unified TCI state groups, and the N Unified TCI state groups correspond to the N TRPs respectively. That is, the Unified TCI states included in the same Unified TCI state group indicate Unified TCI states of the same TRP.

For example, a first Unified TCI state set in a Unified TCI state list indicated by first indication information corresponds to 2 TRPs. Thus, the first Unified TCI state set includes 2 Unified TCI state groups, and the 2 Unified TCI state groups correspond to the 2 TRPs respectively.

In the embodiment of the present disclosure, the number of the Unified TCI state groups and the number of the TRPs have the corresponding relation. The number of the TRPs connected to the terminal can be determined via the number of the Unified TCI state groups corresponding to the Unified TCI state set.

How the first indication information in step S11 indicates the number of the Unified TCI state groups corresponding to each Unified TCI state set in the different Unified TCI state sets in the Unified TCI state list and the number of the Unified TCI states corresponding to each Unified TCI state group in each Unified TCI state set will be described below in detail.

In the method for determining a Unified TCI state according to the embodiment of the present disclosure, the first indication information includes a first information field and a second information field. The first information field is configured to indicate the number of the Unified TCI state groups corresponding to each Unified TCI state set in the different Unified TCI state sets. The second information field is configured to indicate the number of the Unified TCI states corresponding to each Unified TCI state group in each Unified TCI state set.

In the embodiment of the present disclosure, it is easier to determine the number of the Unified TCI state groups and the number of the Unified TCI states by dividing different information fields.

In the method for determining a Unified TCI state according to the embodiment of the present disclosure, bits occupied by the first information field and bits occupied by the second information field are determined based on a high-level configuration or a protocol.

In the embodiment of the present disclosure, when the bits occupied by the first information field and the second information field are specified in the high-level configuration or the protocol, a maximum number of the TRPs supported by the terminal for connection may be implicitly determined based on the bits occupied by the first information field and the second information field.

In an example, if a bit overhead of the first information field is 8 bits, it may be determined that a maximum number of TRPs supported by the terminal for connection is 2; and alternatively, if the bit overhead of the second information field is 16 bits, it may be determined that a maximum number of TRPs supported by the terminal for connection is 2.

In another example, if the bit overhead of the first information field is 16 bits, it may be determined that a maximum number of TRPs supported by the terminal for connection is 4; and alternatively, if the bit overhead of the second information field is 32 bits, it may be determined that a maximum number of TRPs supported by the terminal for connection is 4.

In yet another example, if the bit overhead of the first information field is 32 bits, it may be determined that a maximum number of TRPs supported by the terminal for connection is 8; and alternatively, if the bit overhead of the second information field is 64 bits, it may be determined that a maximum number of TRPs supported by the terminal for connection is 8.

The bits occupied by the first information field and the second information field in the embodiment of the present disclosure may further include other bits apart from the above examples, which are not limited in the embodiment of the present disclosure.

In the method for determining a Unified TCI state according to the embodiment of the present disclosure, every N bits in the bits occupied by the first information field are configured to indicate the number of the Unified TCI state groups corresponding to one Unified TCI state set, different bit values of every N bits are configured to indicate the number of different Unified TCI state groups corresponding to one Unified TCI state set, and N is an integer greater than 0.

In some embodiments, if bits occupied by the first information field are 8 bits, it may be determined that a maximum number of TRPs supported by the terminal for connection is 2. That is, a Unified TCI state set corresponds to 2 Unified TCI state groups at most. In this case, 1 bit is needed to indicate whether one Unified TCI state set corresponds to 1 Unified TCI state group or 2 Unified TCI state groups.

In an example, as shown in FIG. 4, if bits occupied by the first information field are 8 bits (T_0-T_7), each bit is configured to indicate the number of Unified TCI state groups corresponding to a Unified TCI state set. For example, when a bit value of T_0 is a first value (for example, 0), the number of Unified TCI state groups corresponding to a Unified TCI state set corresponding to T_0 is 1, and the Unified TCI state set includes Unified TCI state groups of 1 TRP; and when the bit value of T_0 is a second value (for example, 1), the number of the Unified TCI state groups corresponding to the Unified TCI state set corresponding to T_0 is 2, and the Unified TCI state set includes Unified TCI state groups of 2 TRPs.

In some other embodiments, if bits occupied by the first information field are 16 bits, it may be determined that a maximum number of TRPs supported by the terminal for connection is 4. That is, one Unified TCI state set corresponds to 4 Unified TCI state groups at most. In this case, 2 bits are needed to jointly indicate whether one Unified TCI state set corresponds to 1 Unified TCI state group, 2 Unified TCI state groups, 3 Unified TCI state groups, or 4 Unified TCI state groups.

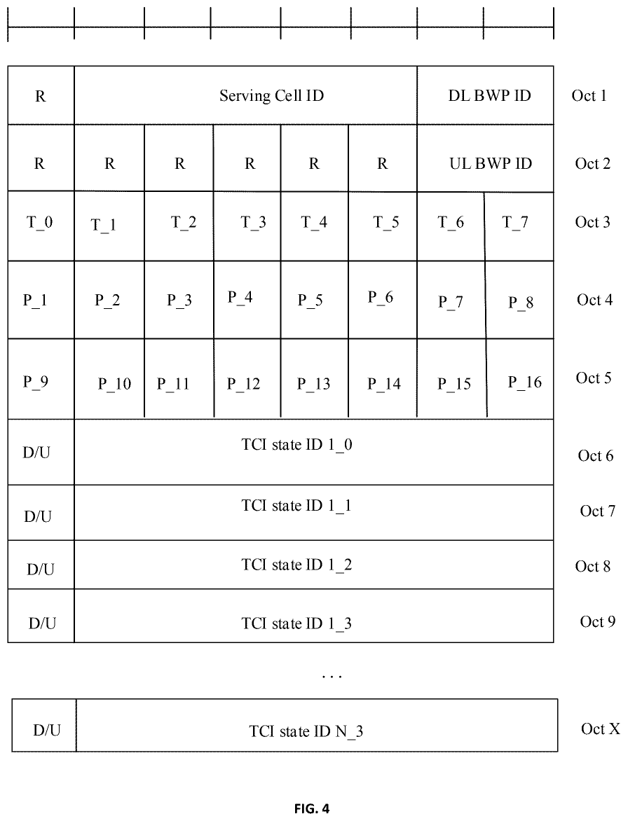

In an example, as shown in FIG. 5, if bits occupied by a first information field are 16 bits (T_0-T_15), every two bits are configured to indicate the number of Unified TCI state groups corresponding to a Unified TCI state set. For example, when bit values of T_0 and T_1 are a first value (for example, 00), the number of Unified TCI state groups corresponding to a Unified TCI state set indicated by T_0 and T_1 is 1, and the Unified TCI state set includes a Unified TCI state group of 1 TRP; when the bit values of T_0 and T_1 are a second value (for example, 01), the number of the Unified TCI state groups corresponding to the Unified TCI state set indicated by T_0 and T_1 is 2, and the Unified TCI state set includes Unified TCI state groups of 2 TRPs; when the bit values of T_0 and T_1 are a third value (for example, 10), the number of the Unified TCI state groups corresponding to the Unified TCI state set indicated by T_0 and T_1 is 3, and the Unified TCI state set includes Unified TCI state groups of 3 TRPs; and when the bit values of T_0 and T_1 are a fourth value (for example, 11), the number of the Unified TCI state groups corresponding to the Unified TCI state set indicated by T_0 and T_1 is 4, and the Unified TCI state set includes Unified TCI state groups of 4 TRPs.

In the embodiment of the present disclosure, the number of the TCI state groups included in the Unified TCI state set is determined by different bit values of every N bits in the bits occupied by the first information field. Thus, the number of TRPs corresponding to the Unified TCI state set is determined.

In the method for determining a Unified TCI state according to the embodiment of the present disclosure, every M bits in the bits occupied by the second information field are configured to indicate the number of the Unified TCI states corresponding to the same Unified TCI state groups in the different Unified TCI state sets, different bit values of each bit in every M bits are configured to indicate the number of different Unified TCI states corresponding to the same Unified TCI state groups in the different Unified TCI state sets, and M is an integer greater than 0.

In some embodiments, if bits occupied by the second information field are 16 bits, it may be determined that a maximum number of TRPs supported by the terminal for connection is 2, every 8 bits in the bits occupied by the second information field are configured to indicate the number of Unified TCI states corresponding to the same Unified TCI state group in different Unified TCI state sets, and different bit values of each bit in every 8 bits are configured to indicate the number of different Unified TCI states corresponding to the same Unified TCI state group in different Unified TCI state sets.

In an example, as shown in FIG. 4, bits occupied by the second information field are 16 bits (P_1-P_16), first 8 bits (P_1-P_8) of the 16 bits are configured to indicate the number of Unified TCI states corresponding to a first Unified TCI state group in each Unified TCI state set separately, and last 8 bits (P_9-P_16) of the 16 bits are configured to indicate the number of Unified TCI states corresponding to a second Unified TCI state group in each Unified TCI state set separately. With P_1 and P_9 as an example, if a bit value of P_1 is a first value (for example, 0), it indicates that a first Unified TCI state group in a Unified TCI state set corresponding to P_1 includes an uplink and downlink joint TCI state. That is, the number of Unified TCI states is 1. If the bit value of P_1 is a second value (for example, 1), it indicates that the first Unified TCI state group in the Unified TCI state set corresponding to P_1 includes the uplink and downlink joint TCI state or an uplink TCI state. That is, the number of the corresponding Unified TCI states is 2. If the bit value of P_9 is the first value (for example, 0), it indicates that a second Unified TCI state group in a Unified TCI state set corresponding to P_9 includes the uplink and downlink joint TCI state. That is, the number of Unified TCI states is 1. If the bit value of P_9 is the second value (for example, 1), it indicates that the second Unified TCI state group in the Unified TCI state set corresponding to P_9 includes the uplink and downlink joint TCI state or the uplink TCI state. That is, the number of the corresponding Unified TCI states is 2.

In some other embodiments, if bits occupied by the second information field are 32 bits, it may be determined that a maximum number of TRPs supported by the terminal for connection is 4, every 8 bits in the bits occupied by the second information field is configured to indicate the number of Unified TCI states corresponding to the same Unified TCI state group in different Unified TCI state sets, and different bit values of each bit in every 8 bits are configured to indicate the number of different Unified TCI states corresponding to the same Unified TCI state group in different Unified TCI state sets.

In an example, as shown in FIG. 5, bits occupied by a second information field are 32 bits (P_1-P_32), P_1-P_8 in the 32 bits are configured to indicate the number of Unified TCI states corresponding to a first Unified TCI state group in each Unified TCI state set separately, and P_9-P_16 are configured to indicate the number of Unified TCI states corresponding to a second Unified TCI state group in each Unified TCI state set separately; P_17-P_24 are configured to indicate the number of Unified TCI states corresponding to a third Unified TCI state group in each Unified TCI state set; and P_25-P_32 are configured to indicate the number of Unified TCI states corresponding to a fourth Unified TCI state group in each Unified TCI state set separately.

In the embodiment of the present disclosure, the number of the Unified TCI states corresponding to each Unified TCI state group included in the Unified TCI state set is determined via different bit values of each bit in every M bits in the bits occupied by the second information field. Thus, the Unified TCI state corresponding to each Unified TCI state group included in the Unified TCI state set is determined.

In the method for determining a Unified TCI state according to the embodiment of the present disclosure, the first indication information is carried in an MAC-CE.

In the method for determining a Unified TCI state according to the embodiment of the present disclosure, the bits occupied by the first information field and the bits occupied by the second information field are newly added bits or reserved bits in the MAC-CE.

In the method for determining a Unified TCI state according to the embodiment of the present disclosure, a type of the Unified TCI state includes an uplink and downlink joint TCI state or an uplink TCI state.

In the method for determining a Unified TCI state according to the embodiment of the present disclosure, the first indication information further includes a third information field, and the third information field is configured to indicate that the type of the Unified TCI state corresponding to the Unified TCI state groups is the uplink and downlink joint TCI state or the uplink TCI state when the plurality of Unified TCI states corresponding to the Unified TCI state groups are provided.

In an example, if a value of the third information field is 0, a type of the Unified TCI state corresponding to a Unified TCI state group is the uplink and downlink joint TCI state; and if the value of the third information field is 1, the type of the Unified TCI state corresponding to the Unified TCI state group is the uplink TCI state.

In the embodiment of the present disclosure, if it is determined based on the second information field that the plurality of the Unified TCI states corresponding to the Unified TCI state group are provided, it may be further determined which type of the Unified TCI state the Type of the Unified TCI state corresponding to the Unified TCI state group is based on the third information. Thus, the type of the Unified TCI state corresponding to each TRP can be determined.

In the method for determining a Unified TCI state according to the embodiment of the present disclosure, second indication information transmitted by the network device is received, where the second indication information is configured to indicate a Unified TCI state set from the Unified TCI state list.

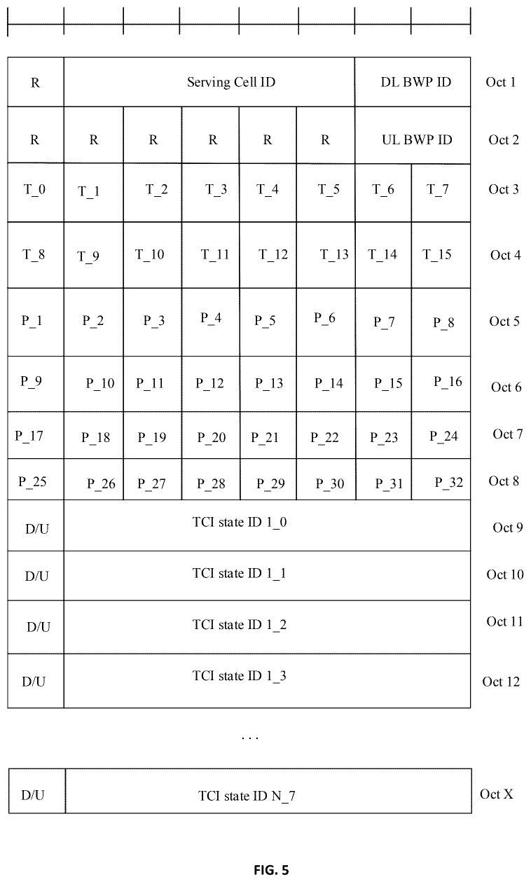

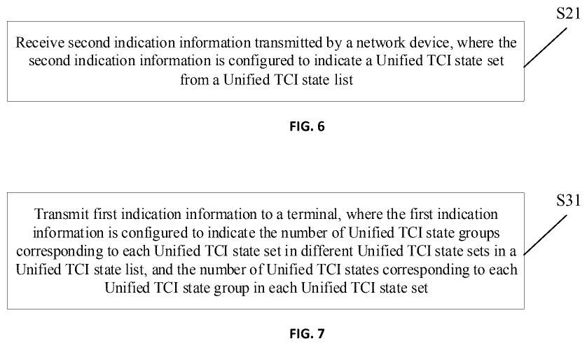

As shown in FIG. 6, FIG. 6 is a flowchart of a method for determining a Unified TCI state according to an example. The method includes the following steps.

In step S21, second indication information transmitted by a network device is received, where the second indication information is configured to indicate a Unified TCI state set from a Unified TCI state list.

In the embodiment of the present disclosure, the terminal determines one Unified TCI state set from the Unified TCI state list via the second indication information, and takes TCI states corresponding to the Unified TCI states included in the Unified TCI state set as the Unified TCI states of the plurality of TRPs connected to the terminal. Thus, a Unified TCI state indication solution in an M-TRP scenario based on S-DCI is implemented.

In the method for determining a Unified TCI state according to an embodiment of the present disclosure, the second indication information is carried in a TCI information field in DCI, the number of code points in a TCI information field in the DCI is the same as the number of a plurality of Unified TCI state sets indicated by the first indication information, and different code points in the TCI information field in the DCI correspond to the different Unified TCI state sets respectively.

In an example, the second indication information indicates Unified TCI state sets in the Unified TCI state list via code points of a TCI information field in DCI.

It should be noted that the embodiment shown in FIG. 6 may be implemented separately. That is, when the embodiment shown in FIG. 6 is implemented separately, the terminal may receive the second indication information for indicating at least one Unified TCI state set transmitted by the network device; and whether the Unified TCI state list needs to be activated or a mode of activating the Unified TCI state list is not limited in the embodiment of the present disclosure. The embodiment shown in FIG. 6 may be implemented in combination with other embodiments of the present disclosure, for example, in combination with the embodiment shown in FIG. 3. That is, the terminal may receive the first indication information, transmitted by the network device, for indicating the number of the Unified TCI state groups corresponding to each Unified TCI state set in the different Unified TCI state sets in the Unified TCI state list, and the number of the Unified TCI states corresponding to each Unified TCI state group in each Unified TCI state set; and the terminal further receives the second indication information, transmitted by the network device, for indicating at least one Unified TCI state. In the embodiment of the present disclosure, the first indication information and the second indication information may be carried in different signaling; and for example, the first indication information is carried in an MAC-CE, and the second indication information is carried in DCI, RRC or other signaling. Certainly, the first indication information and the second indication information may be carried in the same signaling, which are not limited in the embodiment of the present disclosure.

FIG. 7 is a flowchart of a method for determining a Unified TCI state according to an example. AS shown in FIG. 7, the method for determining a Unified TCI state is performed by a network device, and includes the following steps.

In step S31, first indication information is transmitted to a terminal, where the first indication information is configured to indicate the number of Unified TCI state groups corresponding to each Unified TCI state set in different Unified TCI state sets in a Unified TCI state list, and the number of Unified TCI states corresponding to each Unified TCI state group in each Unified TCI state set.

In the embodiment of the present disclosure, the terminal receives the first indication information transmitted by the network device. The first indication information is configured to indicate the number of the Unified TCI state groups corresponding to each Unified TCI state set in the different Unified TCI state sets in the Unified TCI state list, and the number of the Unified TCI states corresponding to each Unified TCI state group in each Unified TCI state set. Thus, when the plurality of TRPs share one piece of DCI, the terminal can determine, based on the first indication information, the Unified TCI state corresponding to each TRP in one Unified TCI state list. Thus, a Unified TCI state indication solution in an M-TRP scenario based on S-DCI is implemented.

At least one of a different target channel of the terminal or reference signals corresponding to the target channel share a beam indicated by the Unified TCI state, and the target channel includes at least one of uplink channels or downlink channels.

In some embodiments, if a Unified TCI state is an uplink TCI state, a beam indicated by the TCI state is applicable to at least one of a PUSCH and/or a DMRS of the PUSCH, at least part of PUCCHs, DMRSs of the PUCCHs, or at least part of SRSs of the terminal.

In some other embodiments, if a Unified TCI state is a downlink TCI state, a beam indicated by the TCI state is applicable to at least one of a PDSCH and/or a DMRS of the PDSCH, at least part of PDCCHs, DMRSs of the PDCCHs, or at least part of CSI-RSs of the terminal.

In some other embodiments, if a Unified TCI state is an uplink/downlink joint TCI state, a beam indicated by the uplink/downlink joint TCI state is applicable to at least one of both an uplink channel and a downlink channel of the terminal and/or corresponding reference signals corresponding to the uplink channel and the downlink channel.

In the method for determining a Unified TCI state according to the embodiment of the present disclosure, the number of the Unified TCI state groups and the number of TRPs have a corresponding relation.

In some embodiments, a corresponding relation between the number of Unified TCI state groups and the number of TRPs is a display corresponding relation. Illustratively, one Unified TCI state group corresponds to a TRP. That is, Unified TCI states included in the same Unified TCI state group indicate Unified TCI states of the same TRP.

For example, if a first Unified TCI state set in a Unified TCI state list indicated by first indication information includes 2 Unified TCI state groups, the terminal supports a connection of 2 TRPs.

In some other embodiments, a corresponding relation between the number of Unified TCI state groups and the number of TRPs is an implicit corresponding relation. Illustratively, a Unified TCI state set corresponds to N TRPs. Thus, one Unified TCI state set includes N Unified TCI state groups, and the N Unified TCI state groups correspond to the N TRPs respectively. That is, the Unified TCI states included in the same Unified TCI state group indicate Unified TCI states of the same TRP.

For example, a first Unified TCI state set in a Unified TCI state list indicated by first indication information corresponds to 2 TRPs. Thus, the first Unified TCI state set includes 2 Unified TCI state groups, and the 2 Unified TCI state groups correspond to the 2 TRPs respectively.

In the embodiment of the present disclosure, the number of the Unified TCI state groups and the number of the TRPs have the corresponding relation. The number of the TRPs connected to the terminal can be determined via the number of the Unified TCI state groups corresponding to the Unified TCI state set.

How the first indication information in step S31 indicates the number of the Unified TCI state groups corresponding to each Unified TCI state set in the different Unified TCI state sets in the Unified TCI state list and the number of the Unified TCI states corresponding to each Unified TCI state group in each Unified TCI state set will be described below in detail.

In the method for determining a Unified TCI state according to the embodiment of the present disclosure, the first indication information includes a first information field and a second information field. The first information field is configured to indicate the number of the Unified TCI state groups corresponding to each Unified TCI state set in the different Unified TCI state sets. The second information field is configured to indicate the number of the Unified TCI states corresponding to each Unified TCI state group in each Unified TCI state set.

In the embodiment of the present disclosure, it is easier to determine the number of the Unified TCI state groups and the number of the Unified TCI states by dividing different information fields.

In the method for determining a Unified TCI state according to the embodiment of the present disclosure, bits occupied by the first information field and bits occupied by the second information field are determined based on a high-level configuration or a protocol.

In the embodiment of the present disclosure, when the bits occupied by the first information field and the second information field are specified in the high-level configuration or the protocol, a maximum number of the TRPs supported by the terminal for connection may be implicitly determined based on the bits occupied by the first information field and the second information field.

In an example, if a bit overhead of the first information field is 8 bits, it may be determined that a maximum number of TRPs supported by the terminal for connection is 2; and alternatively, if the bit overhead of the second information field is 16 bits, it may be determined that a maximum number of TRPs supported by the terminal for connection is 2.

In another example, if the bit overhead of a first information field is 16 bits, it may be determined that a maximum number of TRPs supported by the terminal for connection is 4; and alternatively, if the bit overhead of the second information field is 32 bits, it may be determined that a maximum number of TRPs supported by the terminal for connection is 4.

In yet another example, if the bit overhead of the first information field is 32 bits, it may be determined that a maximum number of TRPs supported by the terminal for connection is 8; and alternatively, if the bit overhead of the second information field is 64 bits, it may be determined that a maximum number of TRPs supported by the terminal for connection is 8.

The bits occupied by the first information field and the second information field in the embodiment of the present disclosure may further include other bits apart from the above examples, which are not limited in the embodiment of the present disclosure.

In the method for determining a Unified TCI state according to the embodiment of the present disclosure, every N bits in the bits occupied by the first information field are configured to indicate the number of the Unified TCI state groups corresponding to one Unified TCI state set, different bit values of every N bits are configured to indicate the number of different Unified TCI state groups corresponding to one Unified TCI state set, and N is an integer greater than 0.

In some embodiments, if bits occupied by the first information field are 8 bits, it may be determined that a maximum number of TRPs supported by the terminal for connection is 2. That is, a Unified TCI state set corresponds to 2 Unified TCI state groups at most. In this case, 1 bit is needed to indicate whether one Unified TCI state set corresponds to 1 Unified TCI state group or 2 Unified TCI state groups.

In some other embodiments, if bits occupied by the first information field are 16 bits, it may be determined that a maximum number of TRPs supported by the terminal for connection is 4. That is, one Unified TCI state set corresponds to 4 Unified TCI state groups at most. In this case, 2 bits are needed to jointly indicate whether one Unified TCI state set corresponds to 1 Unified TCI state group, 2 Unified TCI state groups, 3 Unified TCI state groups, or 4 Unified TCI state groups.

In the embodiment of the present disclosure, the number of the TCI state groups included in the Unified TCI state set is determined by different bit values of every N bits in the bits occupied by the first information field. Thus, the number of TRPs corresponding to the Unified TCI state set is determined.

In the method for determining a Unified TCI state according to the embodiment of the present disclosure, every M bits in the bits occupied by the second information field are configured to indicate the number of the Unified TCI states corresponding to the same Unified TCI state groups in the different Unified TCI state sets, different bit values of each bit in every M bits are configured to indicate the number of different Unified TCI states corresponding to the same Unified TCI state groups in the different Unified TCI state sets, and M is an integer greater than 0.

In some embodiments, if bits occupied by the second information field are 16 bits, it may be determined that a maximum number of TRPs supported by the terminal for connection is 2, every 8 bits in the bits occupied by the second information field are configured to indicate the number of Unified TCI states corresponding to the same Unified TCI state group in different Unified TCI state sets, and different bit values of each bit in every 8 bits are configured to indicate the number of different Unified TCI states corresponding to the same Unified TCI state group in different Unified TCI state sets.

In some other embodiments, if bits occupied by the second information field are 32 bits, it may be determined that a maximum number of TRPs supported by the terminal for connection is 4, every 8 bits in the bits occupied by the second information field is configured to indicate the number of Unified TCI states corresponding to the same Unified TCI state group in different Unified TCI state sets, and different bit values of each bit in every 8 bits are configured to indicate the number of different Unified TCI states corresponding to the same Unified TCI state group in different Unified TCI state sets.

In the embodiment of the present disclosure, the number of the Unified TCI states corresponding to each Unified TCI state group included in the Unified TCI state set is determined via different bit values of each bit in every M bits in the bits occupied by the second information field. Thus, the Unified TCI state corresponding to each TRP included in the Unified TCI state set is determined.

In the method for determining a Unified TCI state according to the embodiment of the present disclosure, the first indication information is carried in an MAC-CE.

In the method for determining a Unified TCI state according to the embodiment of the present disclosure, the bits occupied by the first information field and the bits occupied by the second information field are newly added bits or reserved bits in the MAC-CE.

In the method for determining a Unified TCI state according to the embodiment of the present disclosure, a type of the Unified TCI state includes an uplink and downlink joint TCI state or an uplink TCI state.

In the method for determining a Unified TCI state according to the embodiment of the present disclosure, the first indication information further includes a third information field, and the third information field is configured to indicate that the type of the Unified TCI state corresponding to the Unified TCI state groups is the uplink and downlink joint TCI state or the uplink TCI state when the plurality of Unified TCI states corresponding to the Unified TCI state groups are provided.

In an example, if a value of the third information field is 0, a type of the Unified TCI state corresponding to a Unified TCI state group is the uplink and downlink joint TCI state; and if the value of the third information field is 1, the type of the Unified TCI state corresponding to the Unified TCI state group is an uplink TCI state.

In the embodiment of the present disclosure, if it is determined based on the second information field that the plurality of the Unified TCI states corresponding to the Unified TCI state group are provided, it may be further determined which type of the Unified TCI state the type of the Unified TCI state corresponding to the Unified TCI state group is based on the third information. Thus, the type of the Unified TCI state corresponding to each TRP can be determined.

In the method for determining a Unified TCI state according to the embodiment of the present disclosure, second indication information transmitted by the network device is received, where the second indication information is configured to indicate a Unified TCI state set from the Unified TCI state list.

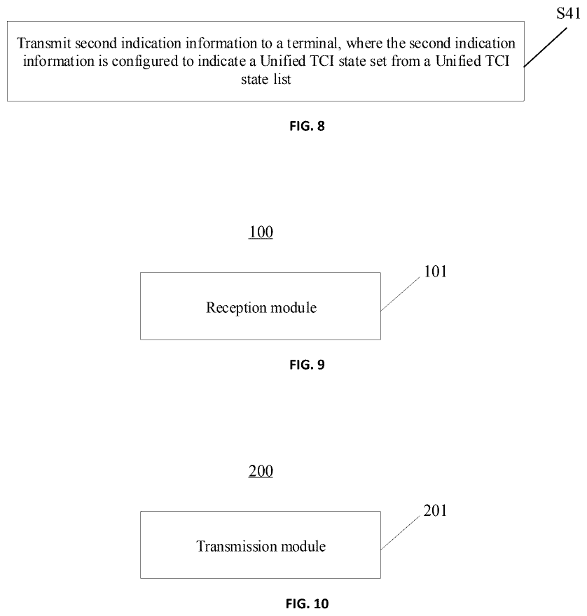

As shown in FIG. 8, FIG. 8 is a block diagram of a method for determining a Unified TCI state according to an example. The method includes the following steps.

In step S41, second indication information is transmitted to the terminal, where the second indication information is configured to indicate a Unified TCI state set from a Unified TCI state list.

In the embodiment of the present disclosure, the terminal determines one Unified TCI state set from the Unified TCI state list via the second indication information, and takes TCI states corresponding to the Unified TCI states included in the Unified TCI state set as the Unified TCI states of the plurality of TRPs connected to the terminal. Thus, a Unified TCI state indication solution in an M-TRP scenario based on S-DCI is implemented.

In the method for determining a Unified TCI state according to an embodiment of the present disclosure, the second indication information is carried in a TCI information field in DCI, the number of code points in a TCI information field in the DCI is the same as the number of a plurality of Unified TCI state sets indicated by the first indication information, and different code points in the TCI information field in the DCI correspond to the different Unified TCI state sets respectively.

In an example, the second indication information indicates Unified TCI state sets in the Unified TCI state list via code points of a TCI information field in DCI.

It should be noted that the embodiment shown in FIG. 8 may be implemented separately. That is, when the embodiment shown in FIG. 8 is implemented separately, the network device may transmit the second indication information for indicating at least one Unified TCI state set to the terminal; and whether the Unified TCI state list needs to be activated or a mode of activating the Unified TCI state list is not limited in the embodiment of the present disclosure. The embodiment shown in FIG. 8 may be implemented in combination with other embodiments of the present disclosure, for example, in combination with the embodiment shown in FIG. 7. That is, the network device may transmit the first indication information for indicating the number of the Unified TCI state groups corresponding to each Unified TCI state set in the different Unified TCI state sets in the Unified TCI state list, and the number of the Unified TCI states corresponding to each Unified TCI state group in each Unified TCI state set to the terminal; and the network device may further transmit the second indication information for indicating at least one Unified TCI state to the terminal. In the embodiment of the present disclosure, the first indication information and the second indication information may be carried in different signaling; and for example, the first indication information is carried in an MAC-CE, and the second indication information is carried in DCI, RRC or other signaling. Certainly, the first indication information and the second indication information may be carried in the same signaling, which are not limited in the embodiment of the present disclosure.

It should be noted that those skilled in the art can understand that various implementations or embodiments mentioned above in the embodiment of the present disclosure can be used in combination with the above embodiments, or can be used independently. Whether various implementations or embodiments mentioned above in the embodiment of the present disclosure are used separately or in combination with the above embodiments, the implementation principles of the implementations or embodiments are similar. In the implementation of the present disclosure, some embodiments are described in a form of the implementations being used together. Certainly, those skilled in the art can understand that such illustrations do not limit the embodiments of the present disclosure.

Based on the same concept, a device for determining a Unified TCI state is further provided in an embodiment of the present disclosure.

It may be understood that in order to achieve the above functions, the device for determining a Unified TCI state according to the embodiment of the present disclosure includes a corresponding hardware structure and/or software module executing each function. In combination with the units and algorithm steps of various examples disclosed in the embodiment of the present disclosure, the embodiment of the present disclosure can be implemented in hardware or a combination of hardware and computer software. Whether a function is executed by hardware or computer software driven hardware depends on the specific application and design constraints of the technical solution. Those skilled in the art can implement the described functions for each specific application via different methods, but such implementation should not be considered beyond the scope of the technical solution of the embodiment of the present disclosure.

FIG. 9 is a block diagram of a device for determining a Unified TCI state according to an example. With reference to FIG. 9, the device includes a reception module 101. The device 100 for determining a Unified TCI state is applied to a terminal.

The reception module 101 is configured to receive first indication information transmitted by a network device, where the first indication information is configured to indicate the number of Unified TCI state groups corresponding to each Unified TCI state set in different Unified TCI state sets in a Unified TCI state list, and the number of Unified TCI states corresponding to each Unified TCI state group in each Unified TCI state set; and

at least one of a different target channel of the terminal or reference signals corresponding to the target channel share a beam indicated by the Unified TCI state, and the target channel includes at least one of uplink channels or downlink channels.

In an implementation, the number of the Unified TCI state groups and the number of TRPs have a corresponding relation.

In an implementation, the first indication information includes a first information field and a second information field.

The first information field is configured to indicate the number of the Unified TCI state groups corresponding to each Unified TCI state set in the different Unified TCI state sets.

The second information field is configured to indicate the number of the Unified TCI states corresponding to each Unified TCI state group in each Unified TCI state set.

In an implementation, bits occupied by the first information field and bits occupied by the second information field are determined based on a high-level configuration or a protocol.

In an implementation, every N bits in the bits occupied by the first information field are configured to indicate the number of the Unified TCI state groups corresponding to one Unified TCI state set, different bit values of every N bits are configured to indicate the number of different Unified TCI state groups corresponding to one Unified TCI state set, and N is an integer greater than 0.

In an implementation, every M bits in the bits occupied by the second information field are configured to indicate the number of the Unified TCI states corresponding to same Unified TCI state groups in the different Unified TCI state sets, different bit values of each bit in every M bits are configured to indicate the number of different Unified TCI states corresponding to the same Unified TCI state groups in the different Unified TCI state sets, and M is an integer greater than 0.

In an implementation, the first indication information is carried in an MAC-CE.

In an implementation, the bits occupied by the first information field and the bits occupied by the second information field are newly added bits or reserved bits in the MAC-CE.

In an implementation, a type of the Unified TCI state includes an uplink and downlink joint TCI state or an uplink TCI state.

In an implementation, the first indication information further includes a third information field, and the third information field is configured to indicate that the type of the Unified TCI state corresponding to the Unified TCI state groups is the uplink and downlink joint TCI state or the uplink TCI state in a case where the plurality of Unified TCI states corresponding to the Unified TCI state groups are provided.

In an implementation, a reception module 101 is further configured to receive second indication information transmitted by a network device, where the second indication information is configured to indicate one Unified TCI state set from the Unified TCI state list.

In an implementation, the second indication information is carried in a TCI information field in DCI, the number of code points in the TCI information field in the DCI is the same as the number of the plurality of Unified TCI state sets indicated by the first indication information, and different code points in the TCI information field in the DCI correspond to the different Unified TCI state sets respectively.

For the device in the above embodiment, a specific mode for each module to execute an operation has been described in detail in the embodiment relating to the method, which will not be repeated here.

FIG. 10 is a block diagram of a device for determining a Unified TCI state according to an example. With reference to FIG. 10, the device includes a transmission module 201. The device 200 for determining a Unified TCI state is applied to a network device.

The transmission module 201 is configured to transmit first indication information to a terminal, where the first indication information is configured to indicate the number of Unified TCI state groups corresponding to each Unified TCI state set in different Unified TCI state sets in a Unified TCI state list, and the number of Unified TCI states corresponding to each Unified TCI state group in each Unified TCI state set; and

at least one of a different target channel of the terminal or reference signals corresponding to the target channel share a beam indicated by the Unified TCI state, and the target channel includes at least one of uplink channels or downlink channels.

In an implementation, the number of the Unified TCI state groups and the number of transmission reception points (TRPs) have a corresponding relation.

In an implementation, the first indication information includes a first information field and a second information field.

The first information field is configured to indicate the number of the Unified TCI state groups corresponding to each Unified TCI state set in the different Unified TCI state sets.

The second information field is configured to indicate the number of the Unified TCI states corresponding to each Unified TCI state group in each Unified TCI state set.

In an implementation, bits occupied by the first information field and bits occupied by the second information field are determined on the basis of a high-level configuration or a protocol.

In an implementation, every N bits in the bits occupied by the first information field are configured to indicate the number of the Unified TCI state groups corresponding to one Unified TCI state set, different bit values of every N bits are configured to indicate the number of different Unified TCI state groups corresponding to one Unified TCI state set, and N is an integer greater than 0.

In an implementation, every M bits in the bits occupied by the second information field are configured to indicate the number of the Unified TCI states corresponding to same Unified TCI state groups in the different Unified TCI state sets, different bit values of each bit in every M bits are configured to indicate the number of different Unified TCI states corresponding to the same Unified TCI state groups in the different Unified TCI state sets, and M is an integer greater than 0.

In an implementation, the first indication information is carried in an MAC-CE.

In an implementation, the bits occupied by the first information field and the bits occupied by the second information field are newly added bits or reserved bits in the MAC-CE.

In an implementation, a type of the Unified TCI state includes an uplink and downlink joint TCI state or an uplink TCI state.

In an implementation, the first indication information further includes a third information field, and the third information field is configured to indicate that the type of the Unified TCI state corresponding to the Unified TCI state groups is the uplink and downlink joint TCI state or the uplink TCI state in a case where the plurality of Unified TCI states corresponding to the Unified TCI state groups are provided.

In an implementation, a transmission module 201 is further configured to transmit second indication information to the terminal, where the second indication information is configured to indicate one Unified TCI state set from the Unified TCI state list.

In an implementation, the second indication information is carried in a TCI information field in DCI, the number of code points in the TCI information field in the DCI is the same as the number of the plurality of Unified TCI state sets indicated by the first indication information, and different code points in the TCI information field in the DCI correspond to the different Unified TCI state sets respectively.

It should be noted that various modules or units involved in the device 100 for determining a Unified TCI state and the device 200 for determining a Unified TCI state involved in the embodiments of the present disclosure are merely illustrative, and are not limited to this. For example, the device 100 for determining a Unified TCI state in the embodiment of the present disclosure may further include a transmitting unit and/or a processing unit. The device 200 for determining a Unified TCI state may further include a receiving unit and/or a processing unit. The units included in the device 100 for determining a Unified TCI state and the device 200 for determining a Unified TCI state may interact with each other, or may interact with other network element devices.

For the device in the above embodiment, a specific mode for each module to execute an operation has been described in detail in the embodiment relating to the method, which will not be repeated here.

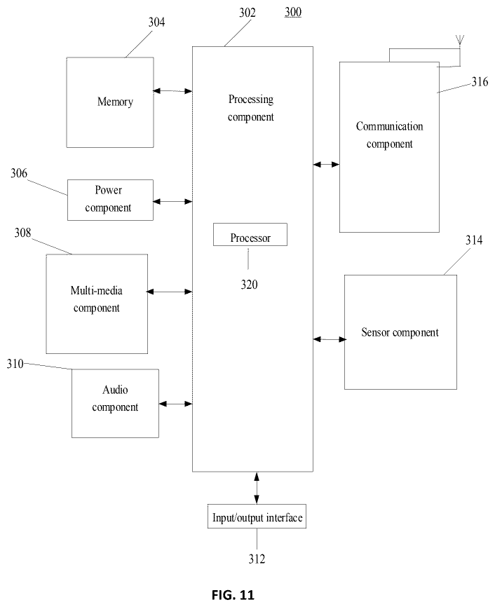

FIG. 11 is a block diagram of a communication device according to an example. For example, the device 300 may be a mobile phone, a computer, a digital broadcast terminal, a message transmitting and receiving device, a game console, a tablet device, a medical device, a fitness device, a personal digital assistant, etc.

With reference to FIG. 11, the device 300 may include one or more of the following components: a processing component 302, a memory 304, a power supply component 306, a multi-media component 308, an audio component 310, an input/output (I/O) interface 312, a sensor component 314 and a communication component 316.

Overall operations of the device 300, such as operations associated with display, phone calls, data communications, camera operations and recording operations, are generally controlled by the processing component 302. The processing component 302 may include one or more processors 320 to execute instructions to complete all or some of steps of the method described above. Further, the processing component 302 may include one or more modules that facilitate interaction between the processing component 302 and other components. For example, the processing component 302 may include a multi-media module, so as to facilitate interaction between the multi-media component 308 and the processing component 302.

The memory 304 is configured to store any type of data to support operations at the device 300. Examples of such data include instructions, contact data, phone book data, messages, pictures, videos, etc., for any application or method operated on the device 300. The memory 304 may be implemented by any type of volatile or non-volatile storage device, or a combination of any type of volatile or non-volatile storage device, such as a static random access memory (SRAM), an electrically erasable programmable read-merely memory (EEPROM), an erasable programmable read-merely memory (EPROM), a programmable read-merely memory (PROM), a read-merely memory (ROM), a magnetic memory, a flash memory, a magnetic disk, or an optical disk.

Power is provided by the power supply component 306 for various components of the device 300. The power supply component 306 may include a power management system, one or more power supplies, and other components associated with generation, management and distribution of power for the device 300.

The multi-media component 308 includes a screen that provides an output interface between the device 300 and a user. In some embodiments, a screen may include a liquid crystal display (LCD) and a touch panel (TP). If the screen includes the TP, the screen may be implemented as a touch screen to receive an input signal from a user. The TP includes one or more touch sensors to sense touch, swipe, and gestures on the TP. A boundary of a touch or swipe action may be sensed by the touch sensor, and duration and pressure associated with a touch or swipe operation may be further detected by the touch sensor. In some embodiments, a multi-media component 308 includes a front-facing camera and/or a rear-facing camera. When the device 300 is in an operation mode, such as a photographing mode or a video mode, external multi-media data may be received by the front-facing camera and/or the rear-facing camera. Each front-facing camera and each rear-facing camera may be a fixed optical lens system or have a focal length and an optical zoom capability.

The audio component 310 is configured to output and/or input an audio signal. For example, the audio component 310 includes a microphone (MIC). The MIC is configured to receive an external audio signal when the device 300 is in an operating mode, such as a call mode, a recording mode, and a voice recognition mode. The received audio signal may be further stored in the memory 304 or transmitted via the communication component 316. In some embodiments, an audio component 310 further includes a loudspeaker for outputting an audio signal.

An interface is provided by the I/O interface 312 between the processing component 302 and a peripheral interface module. The peripheral interface module described above may be a keyboard, a click wheel, a button, etc. The button may include, but not limited to, a home button, a volume button, a start button, and a lock button.

The sensor component 314 includes one or more sensors configured to provide state assessments of various aspects for the device 300. For example, an on/off state of the device 300, and a relative positioning effect of components may be detected by the sensor component 314. For example, the component is a display and a keypad of the device 300. A change in position of the device 300 or a component of the device 300, presence or absence of the user making contact with the device 300, orientation or acceleration/deceleration of the device 300, and a change in temperature of the device 300 may be further detected by the sensor component 314. The sensor component 314 may include a proximity sensor configured to detect presence of nearby objects in the absence of any physical contact. The sensor component 314 may further include a light sensor, such as a complementary metal-oxide-semiconductor (CMOS) image sensor or a charge coupled device (CCD) image sensor, used in imaging applications. In some embodiments, a sensor component 314 may further include an acceleration sensor, a gyro sensor, a magnetic sensor, a pressure sensor, or a temperature sensor.

The communication component 316 is configured to facilitate communication between the device 300 and other devices in a wired or wireless manner. A wireless network based on a communication standard, such as wireless fidelity (WiFi), 2G, 3G, or a combination of the WiFi, the 2G and the 3G, may be accessed by the device s 300. In an example, a broadcast signal or broadcast related information from an external broadcast management system is received by a communication component 316 via a broadcast channel. In an example, a communication component 316 further includes a near field communication (NFC) module to facilitate short range communication. For example, the NFC module may be implemented on the basis of a radio frequency identification (RFID) technology, an infrared data association (IrDA) technology, an ultra wide band (UWB) technology, a Bluetooth (BT) technology, and other technologies.

In an example, the device 300 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is configured to perform the method described above.

In an example, a non-transitory computer-readable storage medium including instructions is further provided, such as a memory 304 including instructions. The instructions are executable by a processor 320 of the device 300, so as to complete the method described above. For example, the non-transitory computer-readable storage medium may be a ROM, a random access memory (RAM), a compact disc read-merely memory (CD-ROM), a magnetic tape, a floppy disk, an optical data storage device, etc.

As used herein, the term processor may refer to one processor that performs the defined functions or a plurality of processors that collectively perform defined functions, such that the execution of the individual defined functions may be divided amongst such processors.

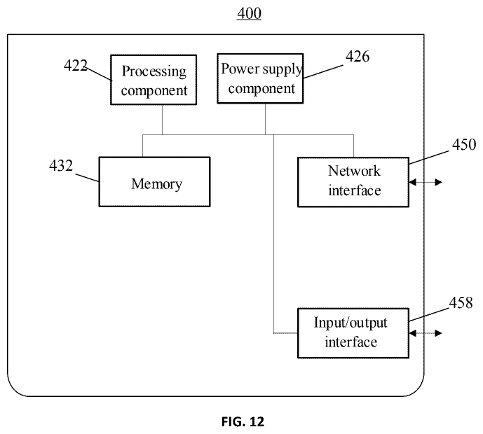

FIG. 12 is a block diagram of a communication device according to an example. For example, the device 400 may be provided as a network device. With reference to FIG. 12, the device 400 includes a processing component 422. The processing component further includes one or more processors, and memory resources represented by a memory 432, which are configured to store instructions, for example, an application, executable by the processing component 422. The application stored in the memory 432 may include one or more modules, each of which corresponds to a group of instructions. Further, the processing component 422 is configured to execute the instructions, so as to perform the method described above.

The device 400 may further include a power supply component 426 configured to perform power management for the device 400, a wired or wireless network interface 450 configured to connect the device 400 to a network, and an input/output (I/O) interface 458. The device 400 may operate an operating system stored in the memory 432, such as Windows Server™ Mac OS X™, Unix™, Linux™, FreeBSD™, or the like.

In an example, a non-transitory computer-readable storage medium including instructions is further provided, such as a memory 432 including instructions. The instructions are executable by a processing component 422 of the device 400, so as to complete the method described above. For example, the non-transitory computer-readable storage medium may be an ROM, an RAM, a CD-ROM, a magnetic tape, a floppy disk, an optical data storage device, etc.

Further, it can be understood that “plurality of” in the present disclosure refers to two or more, and other quantifiers are similar to the term. “And/or” describes an associated relation of an associated object, and indicates that three relations may exist. For example, A and/or B may indicate that A exists separately, A and B exist simultaneously, and B exists separately. The character “/” generally indicates a “or” relation between front and rear associated objects. The singular forms such as “a”, “the” and “this” are also intended to include the plural forms, unless otherwise clearly stated in the context.

Further, it can be understood that the meanings of the words such as “in response to” and “if” mentioned in the present disclosure depend on the context and the actual usage scenario. For example, the word “in response to” used here can be interpreted as “at the time of”, “when” or “if”.

Further, it can be understood that the terms “first”, “second”, etc. are used to describe various information, but these information is not limited by these terms. These terms are merely used to distinguish the same type of information from each other, and do not indicate a particular order or importance. In fact, the expressions “first”, “second”, etc. can be used interchangeably. For example, without departing from the scope of the present disclosure, the first information may also be referred to as second information, and similarly, the second information may also be referred to as first information.

Further, it can be understood that although operations are depicted in a particular order in the accompanying drawings in the embodiments of the present disclosure, the operations should not be construed as requiring that such operations are executed in the particular order shown or in a serial order, or that all illustrated operations are executed to achieve desired results. In a particular environment, multitasking and parallel processing may be advantageous.

Those skilled in the art easily conceive of other implementation solutions of the present disclosure upon consideration of the description and practice of the invention disclosed here. The present application is intended to cover any variations, uses or adaptive changes of the present disclosure. The variations, uses or adaptive changes follow the general principles of the present disclosure and include common general knowledge or customary technical means, which is not disclosed in the present disclosure, in the technical field.

It should be understood that the present disclosure is not limited to a precise structure which has been described above and illustrated in the accompanying drawings, and can have various modifications and changes without departing from the scope of the present disclosure. The scope of the present disclosure is limited by the appended claims merely.

1. A method for determining a unified transmission configuration indicator (Unified TCI) state, performed by a terminal, the method comprising:
receiving first indication information transmitted by a network device, wherein the first indication information is configured to indicate a number of Unified TCI state groups corresponding to a Unified TCI state set in different Unified TCI state sets in a Unified TCI state list, and a number of Unified TCI states corresponding to the Unified TCI state group in the Unified TCI state set; and
at least one of a target channel of terminal or reference signals corresponding to the target channel share a beam indicated by the Unified TCI state, and the target channel comprises at least one of uplink channels or downlink channels.

2. The method according to claim 1, wherein the number of the Unified TCI state groups and a number of transmission reception points (TRPs) have a corresponding relation.

3. The method according to claim 1, wherein the first indication information comprises a first information field and a second information field;
the first information field is configured to indicate the number of the Unified TCI state groups corresponding to the Unified TCI state set in the different Unified TCI state sets; and
the second information field is configured to indicate the number of the Unified TCI states corresponding to the Unified TCI state group in the Unified TCI state set.

4. The method according to claim 3, wherein bits occupied by the first information field and bits occupied by the second information field are determined based on a high-level configuration or a protocol.

5. The method according to claim 4, wherein every N bits in the bits occupied by the first information field are determined as different bit groups, the different bit groups are configured to indicate the number of the Unified TCI state groups corresponding to different Unified TCI state set, different bit values of the bit groups are configured to indicate the number of different Unified TCI state groups corresponding to the Unified TCI state set, and N is an integer greater than 0; and/or
wherein every M bits in the bits occupied by the second information field are configured to indicate the number of the Unified TCI states corresponding to same Unified TCI state groups in the different Unified TCI state sets, different bit values of each bit in every M bits are configured to indicate the number of different Unified TCI states corresponding to the same Unified TCI state groups in the different Unified TCI state sets, and M is an integer greater than 0.

6. (canceled)

7. The method according to claim 1, wherein the first indication information is carried in a medium access control control element (MAC-CE);
wherein the bits occupied by the first information field and the bits occupied by the second information field are newly added bits or reserved bits in the MAC-CE.

8. (canceled)

9. The method according to claim 1, wherein a type of the Unified TCI state comprises an uplink and downlink joint TCI state or an uplink TCI state;
wherein the first indication information further comprises a third information field, and the third information field is configured to indicate that the type of the Unified TCI state corresponding to the Unified TCI state groups is the uplink and downlink joint TCI state or the uplink TCI state in a case where a plurality of Unified TCI states corresponding to the Unified TCI state groups are provided.

10. (canceled)

11. The method according to claim 1, further comprising:
receiving second indication information transmitted by the network device, wherein the second indication information is configured to indicate a Unified TCI state set from the Unified TCI state list;
wherein the second indication information is carried in a TCI information field in downlink control information (DCI), a number of code points in the TCI information field in the DCI is the same as a number of a plurality of Unified TCI state sets indicated by the first indication information, and different code points in the TCI information field in the DCI correspond to the different Unified TCI state sets respectively.

12. (canceled)

13. A method for determining a unified transmission configuration indicator (Unified TCI) state, performed by a network device, comprising:
transmitting first indication information to a terminal, wherein the first indication information is configured to indicate a number of Unified TCI state groups corresponding to a Unified TCI state set in different Unified TCI state sets in a Unified TCI state list, and a number of Unified TCI states corresponding to the Unified TCI state group the Unified TCI state set; and
at least one of a target channel of terminal or reference signals corresponding to the target channel share a beam indicated by the Unified TCI state, and the target channel comprises at least one of uplink channels or downlink channels.

14. The method according to claim 13, wherein the number of the Unified TCI state groups and a number of transmission reception points (TRPs) have a corresponding relation.

15. The method according to claim 13, wherein the first indication information comprises a first information field and a second information field;
the first information field is configured to indicate the number of the Unified TCI state groups corresponding to the Unified TCI state set in the different Unified TCI state sets; and
the second information field is configured to indicate the number of the Unified TCI states corresponding to the Unified TCI state group in the Unified TCI state set.

16. The method according to claim 15, wherein bits occupied by the first information field and bits occupied by the second information field are determined based on a high-level configuration or a protocol;
wherein every N bits in the bits occupied by the first information field are determined as different bit groups, the different bit groups are configured to indicate the number of the Unified TCI state groups corresponding to different Unified TCI state set, different bit values of the bit groups are configured to indicate the number of different Unified TCI state groups corresponding to the Unified TCI state set, and N is an integer greater than 0; and/or
wherein every M bits in the bits occupied by the second information field are configured to indicate the number of the Unified TCI states corresponding to same Unified TCI state groups in the different Unified TCI state sets, different bit values of each bit in every M bits are configured to indicate the number of different Unified TCI states corresponding to the same Unified TCI state groups in the different Unified TCI state sets. and M is an integer greater than 0.

17-18. (canceled)

19. The method according to claim 13, wherein the first indication information is carried in an MAC-CE;
wherein the bits occupied by the first information field and the bits occupied by the second information field are newly added bits or reserved bits in the MAC-CE.

20. (canceled)

21. The method according to claim 13, wherein a type of the Unified TCI state comprises an uplink and downlink joint TCI state or an uplink TCI state;
wherein the first indication information further comprises a third information field, and the third information field is configured to indicate that the type of the Unified TCI state corresponding to the Unified TCI state groups is the uplink and downlink joint TCI state or the uplink TCI state in a case where a plurality of Unified TCI states corresponding to the Unified TCI state groups are provided.

22. (canceled)

23. The method according to claim 13, further comprising:
transmitting second indication information to the terminal, wherein the second indication information is configured to indicate a Unified TCI state set from the Unified TCI state list;
wherein the second indication information is carried in a TCI information field in downlink control information (DCI), a number of code points in the TCI information field in the DCI is the same as a number of a plurality of Unified TCI state sets indicated by the first indication information, and different code points in the TCI information field in the DCI correspond to the different Unified TCI state sets respectively.

24-26. (canceled)

27. A communication device, comprising:
one or more processors; and
a memory for storing processor-executable instructions, wherein
the one or more processors are collectively configured to execute the processor-executable instructions to cause the communication device to:
receive first indication information transmitted by a network device, wherein the first indication information is configured to indicate a number of Unified TCI state groups corresponding to a Unified TCI state set in different Unified TCI state sets in a Unified TCI state list, and a number of Unified TCI states corresponding to a Unified TCI state group in a Unified TCI state set; and
at least one of a target channel of terminal or reference signals corresponding to the target channel share a beam indicated by the Unified TCI state, and the target channel comprises at least one of uplink channels or downlink channels.

28. A communication device, comprising:
one or more processors; and
a memory for storing processor-executable instructions, wherein
the one or more processors are collectively configured to execute the processor-executable instructions to cause the communication device to implement the method for determining a unified transmission configuration indicator (Unified TCI) state according to claim 13.

29. A non-transitory computer-readable storage medium storing instructions, wherein the instructions in the computer-readable storage medium, when executed by one or more processors of a terminal, cause the terminal to perform the method for determining a unified transmission configuration indicator (Unified TCI) state according to claim 1.

30. A non-transitory computer-readable storage medium storing instructions, wherein the instructions in the computer-readable storage medium, when executed by one or more processors of a network device, cause the network device to perform the method for determining a unified transmission configuration indicator (Unified TCI) state according to claim 13.

31. A communication system, comprising: a terminal and a network device, wherein
the terminal is configured to perform the method for determining a unified transmission configuration indicator (Unified TCI) state according to claim 1; and
the network device is configured to perform:
transmitting first indication information to a terminal, wherein the first indication information is configured to indicate a number of Unified TCI state groups corresponding to a Unified TCI state set in different Unified TCI state sets in a Unified TCI state list, and a number of Unified TCI states corresponding to the Unified TCI state group the Unified TCI state set; and
at least one of a target channel of terminal or reference signals corresponding to the target channel share a beam indicated by the Unified TCI state, and the target channel comprises at least one of uplink channels or downlink channels.
